(19) United States
(12) Patent Application Publication
(10) Pub. No.: US 2026/0184098 A1
(43) Pub. Date: Jul. 2, 2026

(54) SECURITY ELEMENT TRANSFER MATERIAL FOR TRANSFERRING SECURITY ELEMENTS HAVING A MICRO-OPTICAL AUTHENTICITY FEATURE AND METHOD FOR PRODUCING SAID SECURITY ELEMENT TRANSFER MATERIAL

(71) Applicant: GIESECKE+DEVRIENT CURRENCY TECHNOLOGY GMBH, Munchen (DE)

(72) Inventors: Josef SCHINABECK, Kreuth (DE); Winfried HOFFMULLER, Bad Tolz (DE); Andreas RAUCH, Ohlstadt (DE); Matthias PFEIFFER, Munchen (DE)

(21) Appl. No.: 18/868,366

(22) PCT Filed: May 26, 2023
(86) PCT No.: PCT/DE2023/100398

§ 371 Date: Nov. 22, 2024

(30) Foreign Application Priority Data
Jun. 1, 2022 (DE) 10 2022 001 915.9

(51) Int. Cl. B42D 25/324; B42D 25/425; B42D 25/455; B42D 25/46; B42D 25/47

(52) U.S. Cl. CPC B42D 25/324; B42D 25/425; B42D 25/455; B42D 25/46; B42D 25/47

(57) ABSTRACT

Security element transfer materials for transferring security elements have a microoptical authenticity feature to an article of value. The microoptical authenticity features create an optical effect by interaction of a first microoptical arrangement having focusing elements with a second microoptical arrangement having micromotif elements. The security element transfer material has a temporary carrier in the form of a layer composite material. The temporary carrier consists of a first temporary carrier substrate and a second temporary carrier substrate, which may be inextricably adhesive-bonded by means of an adhesive layer. The outline shapes of the security elements to be transferred are incised or have been precut. The second temporary carrier substrate is not cut, such that the temporary carrier can be separated off as a complete carrier layer composite. A permanent carrier is bonded inextricably to the microlenses. A transfer adhesive enables adhesion to the final substrate of the article of value.

### BACKGROUND

The invention relates to a security element transfer material for transferring security elements having a microoptical authenticity feature to an article of value, such as a document of value, a security paper or a brand article, to methods of producing the security element transfer material, to methods of indicating the authenticity of an article of value, such as a document of value, a security paper or a brand article, by means of a microoptical authenticity feature, and to an article of value, such as a document of value, a security paper or a brand article, that has been secured against forgery using the security element transfer material.

Articles of value, such as documents of value, ID documents, banknotes, certificates, checks, but also other articles of value, for instance brand articles, and precursors of documents of value such as security papers, are often safeguarded in that they are provided with security elements that permit verification of authenticity of the article of value and simultaneously serve as protection from unauthorized reproduction. The security elements may take the form, for example, of a security filament embedded into a banknote, a cover film for a banknote with an aperture, an applied security strip or a self-supporting film security element, such as a label, which is applied to the document of value after production thereof.

A particular role is played here by security elements that impart a different color impression to the observer at different viewing angles, since such security elements cannot be reproduced even with color copiers of the highest quality. It is known, for example, that security elements can be equipped with security features in the form of diffractive micro- or nanostructures, such as with embossed holograms or other hologram-like diffraction structures.

It is also known that focusing structures such as lens systems can be used as security features. For instance, document EP 0 238 043 A2 describes a security filament made of a transparent material, on the surface of which a pattern of multiple parallel cylinder lenses has been embossed. The thickness of the security filament is chosen such that it corresponds roughly to the focal length of the cylinder lenses. On the opposite surface, a printed image has been applied in exact register, where the printed image is configured with regard to the optical properties of the cylinder lenses.

Further microoptical authenticity features are what are called Moiré magnifier arrangements, as disclosed, for example, in document WO 2006/087138 A1. The security element disclosed in this document has at least one first and one second authenticity feature. The first authenticity feature comprises a first arrangement having a multitude of focusing elements in a first pattern, and a second arrangement having a multitude of microscopic structures in a second pattern. The first and second arrangements are arranged relative to one another such that the microscopic structures of the second arrangement can be seen in magnified form when viewed through the focusing elements of the first arrangement.

The basic motor function of such Moiré magnifier arrangements is described in the article “The moiré magnifier”, M. C. Hutley, R. Hunt, R. F. Stevens and P. Savander, Pure Appl. Opt. 3 (1994), pp. 133-142. In short, Moiré magnification accordingly refers to a phenomenon that occurs when a pattern composed of identical image objects is viewed through a lens pattern having approximately the same spacing. As in the case of any pair of similar patterns, this results in a Moiré pattern, which, in this case, appears as an enlarged and possibly rotated image of the repeat elements of the image pattern.

The focusing elements of microoptical authenticity features are usually embossed in embossing varnishes. The microstructures to be viewed through the focusing elements may in principle be created in any way and be of any shape. For a complete microstructure to be apparent in each case through the focusing elements, typically microlenses, it is necessary for microlenses and microstructures to be of about the same order of size. Moreover, the closer the microstructure is to the focal point of the lens, the greater the magnifying effect of the microlenses. Since focal length is inversely proportional to the curvature of the lens, for good magnification, either the distance between lens and microstructure must be large (with small lens curvature) or a highly curved lens must be used (in the case of a small distance between lens and microstructure).

Since embossing varnishes suitable for embossing of microfocusing elements are costly, it is desirable to use very thin embossing varnish layers. However, thin embossing varnish layers entail restrictions with regard to the focusing structures to be formed. For example, in a thin embossing varnish layer, it is only possible to form lenses having a smaller lens curvature than in a thick embossing varnish layer, for the same lens diameter. Smaller lens curvature in turn entails greater distance from the microstructure to be examined.

From the point of view of forgery security, it is also advantageous to ensure that it is not possible to take an impression of the lenses or other focusing structures. Exposed focusing structures should be avoided if possible, i.e. should be provided with a protective coating where necessary.

In general, security elements are not provided individually, but rather, for example, in the form of transfer tapes having a multitude of security elements in the form of transfer elements. It is characteristic of transfer tapes that the security elements are prepared on a carrier layer, where the sequence of layers of the transfer elements must be the reverse of the sequence to be used later on the article of value to be protected. The carrier layer is typically pulled away from the layer structure of the security elements on transfer. On the opposite side from the carrier layer, the transfer tapes have an adhesive layer, usually of a heat-sealing adhesive, which melts on transfer of the security elements and forms an adhesive bond of the security elements to the article of value to be safeguarded. The transfer tape is placed onto the article of value by the heat-sealing adhesive layer and is pressed on by means of a heated transfer die or a transfer roll and transferred to the article of value in the outline shape of the heated transfer die. Transfer elements, transfer tapes and the transfer of transfer elements to target substrates are described, for example, in documents EP 0 420 261 B1 and WO 2005/108108 A2.

A particular challenge is presented by the provision of film security elements, i.e. of security elements containing a permanent carrier substrate in their layer structure, having microoptical authenticity features in the form of security element transfer materials. Permanent carrier substrates, for example polymer films, have the advantage of stabilizing the security elements, such that they can be used, for example, to close an aperture in a document of value. On the other hand, permanent carrier substrates prevent the possibility of problem-free severance of the security element layer structure in the process of transferring from the security element transfer material to a document of value. Security elements wherein the layer structure comprises a permanent carrier substrate must therefore take the form of prefabricated individual elements on a transfer material, which means that the outline shapes of the security elements have to be precut beforehand in the security element material. Precutting can be conducted, for example, by means of a laser.

The problem arises here that it is necessary to control the cutting depth in a very exact manner, in order on the one hand to sever the complete layer structure of the security element, but on the other hand not to damage the carrier material which is separated off on transfer. This is extremely difficult since the security element layer structures typically have only thicknesses in the range from about 20 μm to 30 μm, and the carrier films have thicknesses in the range from about 10 μm to 30 μm.

Carrier materials used are typically polymer films. Although these have high tear resistance, they have low tear propagation resistance. When they are cut, it is therefore barely possible to avoid tearing in some places of the security element transfer material in the form of continuous material over the course of the process of transferring the security elements to articles of value. If, on the other hand, the layer structure of the security element is not completely severed, the security element can be damaged in the course of transfer, which leads to impairment of the observed visual effects and in the worst case to complete un-usability of the security element transferred to the article of value.

Security element transfer materials having security elements having microoptical authenticity features that are producible in a precise and inexpensive manner and have a stabilizing carrier film in their layer structure but can nevertheless be transferred to a document of value without difficulty, i.e. without risk of damage to the microoptical features and without risk of tearing of the temporary carrier material, are unavailable to date.

### SUMMARY

It is therefore an object of the present invention to provide such security element transfer materials and methods of production thereof. In order to increase forgery security, it should preferably not be possible to take an impression of the focusing elements of the security elements. They should preferably also be protected against wear and soiling, since, in the case of soiled or worn focusing elements, impeccable visibility of the optical effects is no longer assured.

It is also an object of the present invention to provide a method of indicating the authenticity of an article of value by transferring a security element having a stabilizing carrier film, wherein authenticity is indicated by means of a microoptical authenticity feature.

It is a further object of the present invention to provide an article of value that has a microoptical authenticity feature to indicate authenticity.

In a first embodiment of the invention, the first microoptical arrangement is produced by applying an embossing varnish having (a) high or (b) low refractive index to a permanent carrier substrate or a temporary carrier, embossing a focusing structure, especially a microlens structure, into the embossing varnish and applying the temporary carrier or the permanent carrier substrate by lamination by means of a laminating varnish, where, in case (a), a laminating varnish of low refractive index and, in case (b), a laminating varnish of high refractive index is used.

The temporary carrier used may be a multilayer carrier as disclosed in document WO 2010/031543 A1, where the carrier is preferably not used as a finished carrier composite, but rather produced over the course of the method of producing the security element transfer material.

In this first embodiment, precisely focusing elements are created by the interface between the varnish having high refractive index and the varnish having low refractive index. It is not possible to make an impression of the focusing elements since they are within the double varnish layer, and therefore the microoptical authenticity feature is protected in a particularly forgery proof manner and is well protected against wear and soiling.

The second microoptical arrangement having micromotif elements is formed on the surface of the permanent carrier substrate remote from the first microoptical arrangement, preferably by printing. However, the production of the second microoptical arrangement is not restricted in any way and can be effected in any manner known to the person skilled in the art, for example by embossing as well.

The first embodiment of the inventive production of security element transfer materials comprises two variants that are shown in FIGS. 3 and 4 and are elucidated in detail in connection with the description of these figures.

In a second embodiment of the present invention, the first microoptical arrangement is produced by applying an embossing varnish to a (a) temporary or (b) permanent carrier substrate, embossing a focusing structure, especially a microlens structure, in the embossing varnish, and applying the permanent carrier substrate in case (a) or the temporary carrier substrate in case (b) by lamination by means of a laminating varnish.

In the second embodiment, the focusing elements are formed either by the focusing structure embossed into the embossing varnish or by the complementary structure created in the laminating varnish.

One of the two varnish layers, i.e. either the embossing varnish layer or the laminating varnish layer, is removed together with the temporary carrier on transfer of the security element to a document of value, meaning that it forms part of the temporary carrier.

A temporary carrier substrate used may be a single polymer film or a carrier layer composite as disclosed in document WO 2010/031543 A1.

The second microoptical arrangement is formed on the surface of the permanent carrier substrate remote from the first microoptical arrangement.

The inventive method of producing a security element transfer material in the second embodiment is shown in FIG. 5 and elucidated in detail in association with the description of that figure.

In a third embodiment of the present invention, the security elements of the security element transfer material contain solely the first microoptical arrangement of the microoptical authenticity feature, while the second microoptical arrangement is formed on the article of value itself.

In the third embodiment of the present invention, the first microoptical arrangement may be produced as in the two variants of the first embodiment or as in the second embodiment.

The indication of authenticity of an article of value according to the third embodiment is illustrated in FIGS. 6 and 7, and elucidated in detail in association with the description of those figures.

### BRIEF DESCRIPTION OF THE DRAWINGS

The present invention is elucidated hereinafter by figures. The embodiments shown should be considered to be purely illustrative, and in no way limiting. For better clarity, the representation in the figures is not true to scale or true to proportion. Only the elements essential for understanding of the embodiment in question are shown in each case. In fact, security elements have not only the layers or layer sequences shown in each case but additional functional layers and/or auxiliary layers. Since they are not essential to the understanding of the embodiments of the present invention and are within the knowledge of a person of average skill in the art, they are not shown explicitly in the figures. Identical or corresponding elements are given the same reference numerals in the figures.

The figures show:

FIG. 1 shows a front view of a document of value having a security element made from a security element transfer material of the invention,

FIG. 2 shows a front view of a security element transfer material according to the invention as shown in FIGS. 3a to 3i, in FIGS. 4a to 4g, in FIGS. 5a to 5h and FIGS. 6a, 6b,

FIG. 3a to FIG. 3i show method stages in the production of a security element transfer material according to the first embodiment, variant 1, of the invention, and the transfer of a security element from the security element transfer material to an article of value, shown in the section along line A-A′ of FIG. 2,

FIG. 4a to FIG. 4g show method stages in the production of a security element transfer material according to the first embodiment, variant 2, of the invention, and the transfer of a security element from the security element transfer material to an article of value, shown in the section along line A-A′ of FIG. 2,

FIG. 5a to FIG. 5h show method stages in the production of a security element transfer material according to the second embodiment of the invention, and the transfer of a security element from the security element transfer material to an article of value, shown in the section along line A-A′ of FIG. 2,

FIG. 6a to FIG. 6c show method stages in the indication of authenticity of an article of value according to the third embodiment of the invention, shown in cross section, and

FIG. 7 shows a cross section through a document of value according to the third embodiment of the invention.

### DETAILED DESCRIPTION OF VARIOUS EMBODIMENTS

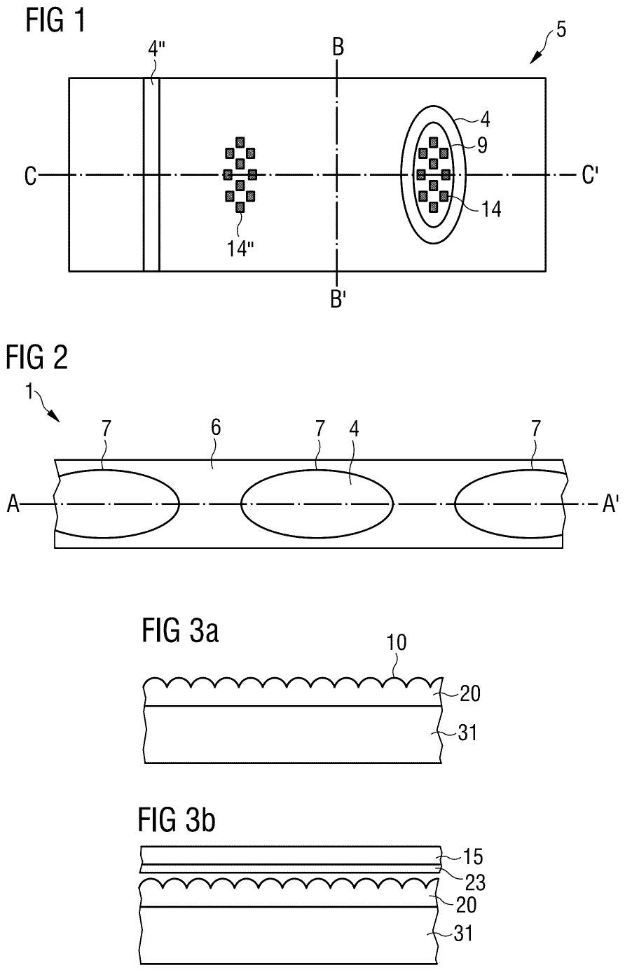

FIG. 1 is a front view of a document of value 5 having a security element 4 that has been transferred from an inventive security element transfer material 1 to the document of value. The embodiment shown is a banknote which, apart from the inventive security element 4, has a further security element, the security filament 4″.

The inventive security element 4 is a film patch that closes an aperture 9 in the document of value. Also shown are micromotif elements 14 and micromotif elements 14′, which will be described in more detail later on.

FIG. 2 shows an inventive security element transfer material 1 in which the security elements have been precut in front view. The security elements 4 have outline shapes 7 and are surrounded by the region 6 from which the security element layer composite material has already been removed. FIG. 2 shows the inventive security element transfer material 1 as a continuous strip on which there is only ever one security element in widthwise direction. In practice, the continuous strips may be broader and may comprise a multitude of security elements arranged alongside one another.

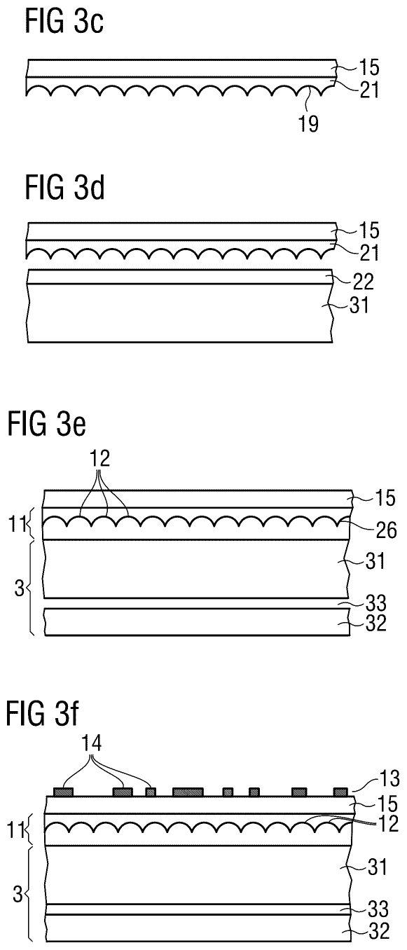

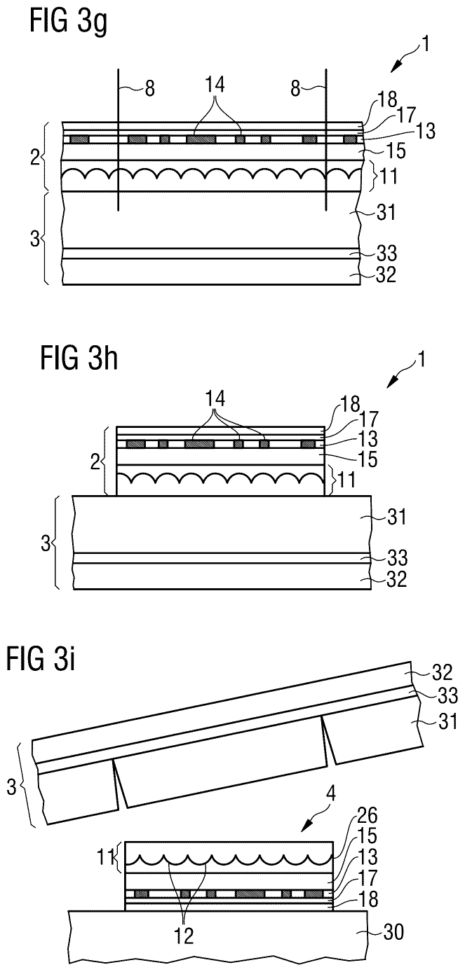

FIGS. 3a to 3i show method stages in the production of a security element transfer material 1 according to a first embodiment, variant 1, of the present invention, and the transfer of a security element 4 from the security element transfer material to a document-of-value substrate 30, in each case shown in the section along line A-A′ of FIG. 2.

First of all, as shown in FIG. 3a, a layer of an embossing varnish 20 having high refractive index is applied to an embossing film 31, and a focusing structure 10, for example convex microlenses, is embossed into the embossing varnish layer 20. The embossing film 31 forms part of the temporary carrier 3 which is pulled away from the security elements when the security elements are transferred to an article of value, i.e. only “temporarily” serves as carrier for the security elements.

Thereafter, as shown in FIG. 3b, a film 15 is laminated onto the embossing varnish layer 20 by means of a laminating varnish 23 having low refractive index. The laminating varnish must have sufficiently low viscosity that it matches the focusing structure 10 perfectly, i.e. forms an exactly complementary structure at the interface to the focusing structure 10. The interface 26 (FIG. 3e) forms the focusing elements 12 of the first microoptical arrangement.

Alternatively, as shown in FIG. 3c, a layer of an embossing varnish 21 having low refractive index can be applied to an embossing film 15, and a focusing structure in inverse form 19, for example concave microlenses, can be embossed into the embossing varnish layer 21. The embossing film 15 is the permanent carrier substrate of the security elements 4 to be transferred, i.e. the film that remains permanently in the security element layer composite as stabilizing element.

Thereafter, as shown in FIG. 3d, a film 31 is laminated onto the embossing varnish layer 21 by means of a laminating varnish 22 having high refractive index. The laminating varnish must have sufficiently low viscosity that it matches the inversely embossed focusing structure 19 perfectly, i.e. forms an exactly complementary structure at the interface to the structure 19. The interface 26 (FIG. 3e) forms the focusing elements 12 of the first microoptical arrangement.

Prior to lamination, the focusing structure 10 or the inverse focusing structure 19 must have cured naturally.

In both procedures, a first microoptical arrangement 11 having microfocusing elements 12 is obtained, which is formed by an interface 26 having a focusing structure between a varnish layer having high refractive index and a varnish layer having low refractive index, as apparent from FIG. 3e. The first microoptical arrangement 11 is between films 15 and 31, which respectively constitute the permanent carrier substrate of the security elements and part of the temporary carrier 3. The temporary carrier 3 is then completed by laminating application of a support film, i.e. a second temporary carrier substrate 32, to the temporary carrier substrate 31 by means of a lamination adhesive 33 that inextricably bonds the temporary carrier substrate 31 and the temporary carrier substrate 32 to one another.

For creation of the microoptical authenticity feature, a second microoptical arrangement 13 is produced on the surface of the permanent carrier substrate 15 remote from the temporary carrier 3 and the first microoptical arrangement 11, as shown in FIG. 3f. The second microoptical arrangement 13 has micromotif elements 14 which, together with the microfocusing elements 12, for example, form a Moiré magnifier arrangement or create a tilted image or some other optical effect.

The laminating varnish layer is advantageously just thick enough for the depressions or interstices in the embossing structure of the embossing varnish layer to be completely filled, such that the interface to the permanent carrier substrate applied by lamination or the temporary carrier substrate applied by lamination is completely flat.

The thickness of the permanent carrier substrate 15 and the thickness of the adjoining varnish layer having low refractive index must be matched to the geometry of the micro-focusing elements 12; in other words, the focal length of the microfocusing elements 12 and the position of the micromotif elements 14 must be matched to one another for observation of the desired optical effect. It is advantageous to use very thin varnish layers since the varnishes required are very costly, and to assure the requisite distance from the second microoptical arrangement 13 by choice of a thicker (inexpensive) permanent carrier substrate 15.

For adhesive bonding of the security elements 4 to be transferred to an article of value to be safeguarded, the final layer applied is a transfer adhesive layer 18, typically of a heat-sealing varnish. In the diagram according to FIG. 3g, adhesion between the transfer adhesive layer 18 and the second microoptical arrangement 13 is improved by providing a primer layer 17. The first microoptical arrangement 11, the permanent carrier substrate 15, the second microoptical arrangement 13, the optional primer layer 17 and the transfer adhesive layer 18 form the security element layer composite 2; the first temporary carrier substrate 31, the second temporary carrier substrate 32 and the adhesive layer 33 that inextricably bonds the two temporary carrier substrates to one another form the carrier layer composite of the temporary carrier 3.

FIG. 3g shows the security element transfer material 1 after the outline shapes 7 (see FIG. 2) of the later security elements 4 have been incised into the security element layer composite 2, for example by laser. The cuts are shown as lines 8. The cuts 8 cut through not only the security element layer composite 2, but also cut partly through the first temporary carrier substrate 31. They may also penetrate into the adhesive layer 33 under some circumstances.

The security element transfer material 1 is usable in principle in the state shown in FIG. 3g. For transfer to articles of value, in this case, it is necessary to use a transfer die corresponding to the outline shape of the security elements 4, and, in the transfer of the security elements, to bring the transfer die into line with each of the security elements 4 on the security element transfer material 1.

In a preferred embodiment, the material of the security element layer composite 2 which is not to be transferred is removed such that the security elements 4 to be transferred are spaced apart on the temporary carrier 3. The removing of the excess security element layer composite material is also referred to as “stripping”, since the excess security element layer composite material forms a coherent grid with recesses in the form of the security elements remaining on the temporary carrier, which can be pulled off/removed from the temporary carrier in an analogous manner to a separation winding.

The state after stripping is shown in FIG. 3h in cross section and in FIG. 2 in front view. As apparent from FIG. 2, the security elements 4 are spaced apart and are separated from one another by regions 6 in which there is no longer any security element composite material. In this case, it is unnecessary to use a transfer die in the outline shape of the security elements, and to bring this transfer die into line with the security elements in the transfer operation. Instead, the security elements can be transferred, for example, by means of a heated unstructured transfer roll.

The result of the transfer of a security element 4 to an article of value is illustrated schematically in FIG. 3i. The security element 4 is transferred by bringing together the security element transfer material 1 and the article of value, a document-of-value substrate 30 in the embodiment shown, for example a security paper, by compressing the security element transfer material 1 in the region of the security element 4 to be transferred and the article of value, optionally at elevated temperature, and separating the temporary carrier 3 as a complete carrier layer composite from the transferred security element 4.

At the points where the cuts 8 have penetrated into the first temporary carrier substrate 31, pulling of the temporary carrier 3 away from the transferred security element 4 forms cracks that completely sever the first temporary carrier substrate 31 but have not penetrated into the adjacent adhesive layer 33, let alone into the second temporary carrier substrate 32. The temporary carrier 3 can therefore be pulled off as a complete carrier layer composite.

After transfer to the document of value, the security element 4 is present with the reverse layer sequence from that on the security element transfer material 1, i.e. the layer of high-refracting varnish is the layer facing an observer. The focusing elements 12 formed by the interface 26 between the layers of the varnish having high refractive index and of the varnish having low refractive index are within the microoptical arrangement 11 and are well protected against wear, soiling and attempts to take impressions for forgery purposes.

The security element layer composite 2 of the embodiment described above, and also of the other embodiments or variants of embodiments of the present invention, may of course contain further layers. Such further layers are, for example, feature layers. A feature layer (or else function layer) is a layer having visually discernible and/or machine-detectable features. Such layers are known to a person skilled in the art. The materials, layer sequences and modes of application are not restricted in any way. Instead, all materials, layer sequences and modes of application are suitable, provided that they do not impair the microoptical authenticity feature of the security elements. In this respect, for example, feature layers having strongly colored pigments such as magnetic pigments that would impair the visibility of the microoptical authenticity feature are less likely to be suitable unless a (perceptible) overlap with the microoptical authenticity feature can be avoided.

Auxiliary layers that should be mentioned are especially primer layers to improve adhesion between adjacent layers, and release layers to reduce adhesion between adjacent layers. In the present invention, it is essential that there is an inextricable bond between particular layers of the security element transfer material, while there is an extricable bond between other layers of the security element transfer material. Which layers have to be bonded inextricably to one another and which layers have to be bonded extricably to one another will be immediately apparent on consideration of the operation of transferring the security elements to a document of value.

The layers that form the security element layer composite must be bonded inextricably to one another since the parting of a bond between two adjacent layers, whether directly in the production of the security element transfer material, in the transfer operation to the document of value, or later in the use of the document of value, would make the security element unusable. Considering the embodiment shown in FIG. 3, an inextricable bond is very particularly important at the interface 26 between the varnish layer having high refractive index and the varnish layer having low refractive index, since parting of the bond between the two varnish layers would destroy the function of the first microoptical arrangement.

What is thus meant by “inextricable” in this connection is that the bonding of the layers in processes for processing or treating the security element transfer material cannot be parted in the transfer of the security elements to an article of value, or in the use of the articles of value.

It is likewise the case that the layers of the carrier layer composite of the temporary carrier must not become parted from one another during the operation of transferring the security elements to an article of value. Considering the embodiment shown in FIG. 3, the adhesive layer 33 must inextricably bond the first temporary carrier substrate 31 to the second temporary carrier substrate 32. What is thus meant by “inextricable” in this connection is that the adhesive bond cannot be parted at least in the process of transferring the security elements or in any processes for processing or treating the security element transfer material.

In order to improve adhesion between layers that have to be bonded inextricably to one another, if necessary, an adhesion promoter or primer can be applied or an adhesion-improving pretreatment can be conducted.

By contrast, the security element layer composite has to be easily detachable as a whole from the temporary carrier. Considering the embodiment shown in FIG. 3, the varnish layer 20 or varnish layer 22 thus has to be bonded extricably to the temporary carrier substrate 31. What is thus meant by “extricable” in this connection is that the bond can be parted without difficulty during the operation of transferring the security elements to an article of value. Since the transfer is typically effected by heat-sealing, the bond between security element and temporary carrier has to be partable under heat-sealing conditions.

In order to improve extricability, if required, an adhesion-reducing pretreatment of the temporary carrier substrate 31 may be undertaken or a release layer may be provided between the temporary carrier substrate 31 and the varnish layer 20 or varnish layer 22.

Release layers may under some circumstances also lead to problems, for example as a result of undefined splitting of the release layer on transfer of the security elements or when the first microoptical arrangement of a security element is to be subjected to further treatment after transfer to an article of value, for example partial printing. Overprinting of layers having residues of release layers often leads to imperfect printed images. It is therefore preferable to ensure good extricability of the security elements from the temporary carrier either by using temporary carrier films and varnishes having low adhesion capacity to one another or (considering the embodiment shown in FIG. 3) by giving adhesion-reducing pretreatment to the temporary carrier substrate 31 prior to bonding to the varnish layer 20 or varnish layer 22.

Of central significance in the first embodiment of the present invention is the choice of suitable materials for the embossing varnish layer and for the laminating varnish layer or the laminating adhesive layer. As set out above, either an embossing varnish having high refractive index (a “high-refracting embossing varnish”) is combined with a laminating varnish or laminating adhesive having low refractive index (a “low-refracting laminating varnish”), or an embossing varnish having low refractive index (a “low-refracting embossing varnish”) is combined with a laminating varnish or laminating adhesive having high refractive index (a “high-refracting laminating varnish”). The interface between the varnishes forms the first microoptical arrangement. High-refracting varnishes in the context of the present invention are varnishes having a refractive index n>1.55, preferably n>1.6, and more preferably n>1.7. Low-refracting varnishes in the context of the present invention are varnishes having a refractive index n<1.45, preferably n<1.3. The refractive indices are measured at 589 nm and 20° C. Preference is given to using combinations of varnishes having refractive indices that differ by at least 0.2, preferably at least 0.3.

Varnishes having high refractive index are disclosed, for example, in document WO 2008/098753 A1, to which explicit reference is made in this regard. The embossing varnishes having high refractive index that are mentioned in this document are suitable as high-refracting embossing varnishes for the purposes of the present invention. These are especially free-radically curing and cationically curing UV embossing varnishes. The refractive indices of these embossing varnishes may be increased further by the addition of inorganic particles, which are preferably used in the form of nanoparticles. Document WO 2008/098753 A1 disclose numerous materials suitable for increasing refractive indices. Particular preference is given to TiO₂, ZrO₂, Fe₂O₃, Fe₃O₄, Cr₂O₃, ZnO, Al₂O₃ and ZnS. The particles may, for example, be incorporated by polymerization into the embossing varnish. The high-refracting varnishes disclosed in WO 2008/098753 A1 have the particular advantage that the addition of the refractive index-increasing nanoparticles does not lead to significant light scatter, by contrast with many other embossing varnishes.

High-refracting embossing varnishes of very good suitability may also include, by way of example, the MO-33 (n=1.602) and MO-SO-01 UV embossing varnishes from C-Coatings B.V.

These embossing varnishes having high refractive index are combined with a laminating varnish having low refractive index. Suitable low-refracting laminating varnishes are the customary laminating varnishes used in the lamination of films. The following UV-curing adhesives may be mentioned by way of example: NOA1315, NOA132, NOA1327, NOA1328, NOA133, NOA1348, NOA136, NOA13685, NOA1369, NOA1375, NOA13775, NOA138, NOA13825 and NOA139 from Norland, having refractive indices between 1.315 and 1.39. Also of good suitability is the LOCA-133 laminating varnish with n=1.33.

Low-refracting embossing varnishes used may be the embossing varnishes that are customary in the field of security elements. Low-refracting embossing varnishes that are of good suitability for the purposes of the present invention are obtainable from Shin-A T&C (Korea). The low-refracting embossing varnishes may advantageously be combined with high-refracting laminating varnishes from Norland, for example the NOA160, NOA161H, NOA1622H, NOA1639H, NOA165H, NOA1665 and NOA170 UV-curing laminating adhesives that have refractive indices between 1.60 and 1.70. The NOA161H, NOA1622H, NOA1639H and NOA165H laminating adhesives are also heat-curing.

In the second embodiment of the invention, no embossing varnishes and laminating varnishes having specific refractive indices are required.

The laminating varnishes must have sufficiently low viscosity that they match the (inversely) embossed focusing structure perfectly, i.e. form an exactly complementary structure at the interface to these structures. In the case of solvent-based laminating adhesives, viscosity can be controlled, for example, by addition of solvents.

In order to permit the formation of focusing elements of suitable shape, the embossing varnish layer has to be comparatively thick. Typical layer thicknesses are in the range between 5 and 50 μm. Especially for embossing varnish layers close to the upper end of this range, it is preferable to apply the embossing varnish layer in two or more steps. If the embossing varnish layer is applied in two or more steps, it is preferable to proceed by the method described in document EP 1 879 154 A2. In this method, the embossing varnish layer is applied wet-to-wet in multiple steps, i.e. a first embossing varnish layer is first applied to the temporary carrier, the first layer is optionally cured partly, but not completely, then a second embossing varnish layer and optionally further embossing varnish layers are applied thereto, then at least the uppermost layer of the coating is embossed with a microstructure, and then the entire coating is cured.

The focusing elements are preferably microlenses, for example spherical microlenses or cylindrical lenses. However, the type of focusing elements is not restricted in any particular way, apart from the fact that they must be suitable in terms of shape and arrangement for interacting with the micromotif elements of the second microoptical arrangement and creating an optical effect.

It is advantageous, in the first embodiment of the invention, first to produce the layer composite composed of first microoptical arrangement, permanent carrier substrate and first temporary carrier substrate, and only then to adhesive-bond the first temporary carrier substrate to the second temporary carrier substrate. The thinner the layer structure in the laminating operation for creation of the first microoptical arrangement, the higher the quality of the interface between the embossing varnish layer and the laminating varnish layer will be, and hence the quality of the focusing elements of the first microoptical arrangement. Moreover, this avoids stresses on the second temporary carrier substrate during the process for production of the security element transfer material that could lead to weakening of the second temporary carrier substrate.

Permanent carrier substrates used are transparent or translucent polymer films, for example films of polyester, such as polyethylene terephthalate, or of polyethylene or polypropylene. The thickness of the permanent carrier substrates is preferably chosen such that the permanent carrier substrate, together with the thickness of the embossing varnish layer or the thickness of the laminating varnish layer, according to the structure of the security element, results in the appropriate focal length for observation of the second microoptical arrangement.

The second microoptical arrangement is preferably produced in the present invention by printing of micromotif elements onto the surface of the permanent carrier substrate remote from the first microoptical arrangement. However, the micromotif elements may also be created in some other way, for example by embossing. One production method for high-resolution microstructures is called microcontact printing (μCP). This method can achieve a resolution of less than 1 μm. The microstructures are produced by means of semiconductor structuring techniques and then an impression is taken with an elastomer. This gives rise to a flexible die or print cylinder of detailed structure, which is suitable for transfer of very thin ink layers in the case of use of specific printing inks and surface treatment of the print substrate. By application of a suitable ink with the aid of a print cylinder produced in this way, it is thus possible to create a second microoptical arrangement with high-resolution micromotif elements. Primer layers may be required in order to improve the adhesion of the micromotif layer to its adjacent layers.

An essential element of the present invention is also the use of a layer composite material as temporary carrier, which enables incision of the outline shapes of the security elements to be transferred and complication-free and damage-free transfer thereof to a document-of-value substrate. The concept of formation of the temporary carrier as layer composite is disclosed in document WO 2010/031543 A1, the disclosure content of which with regard to materials and methods of production of the temporary carrier layer composite is incorporated into the present application.

Since, in the security element transfer materials of the present invention, the first microoptical arrangement having the focusing elements is bonded directly to the temporary carrier, i.e. is parted therefrom during the transfer operation and is therefore damaged in the case of incomplete severing of the security element layer composite, it is necessary to incise the security element transfer material sufficiently deeply that the security element layer composite is completely severed with certainty. It is unavoidable here that the temporary carrier is cut, under some circumstances to a considerable depth. It is therefore preferable in the present invention to perform the incising of the security element outline shapes by means of a laser and to provide a laser protection layer between the first temporary carrier substrate and the adhesive layer and/or between the second temporary carrier substrate and the adhesive layer, for example to subject the temporary carrier substrates to vapor deposition of a laser-absorbing or laser-reflecting substance. Alternatively or additionally, the adhesive between the temporary carrier substrates may be equipped with laser-absorbing or laser-reflecting substances, which protects the temporary carrier substrate beneath.

The incision of the outline shapes of the security elements need not necessarily be conducted by means of a laser, but can also be effected in other ways, for example by punching.

It is also particularly advantageous to use a “self-healing” adhesive as adhesive for adhesive-bonding of the temporary carrier substrates. Self-healing adhesives are adhesives that cure only gradually, such that an adhesive layer damaged during the curing operation is still reactive enough to reverse the damage over the course of the curing operation. If a self-healing adhesive is used and the cutting of the outlines of the security elements is conducted at a time when the adhesive has still not fully cured, cuts in the adhesive layer may be reversed. The still-plastic adhesive may even penetrate into cuts in the temporary carrier substrates and completely or partly fill them or at least adhesive-bond them to such an extent that the stability of the cut temporary carrier substrates is not significantly compromised.

The layer composite of the temporary carrier may also comprise more than two temporary carrier substrates, where two temporary carrier substrates in each case are adhesive-bonded by means of an adhesive layer, preferably a self-healing adhesive layer. A greater number of layers also offers the option of providing a greater number of laser protection layers, meaning that the resistance of the temporary carrier to cutting damage can be increased with the number of temporary carrier substrates that it possesses.

Transfer adhesives used for adhesive bonding of a transferred security element to the article of value to be labeled may be the transfer adhesives known to a person skilled in the art, especially heat-sealing adhesives. Preference is given to heat-sealing adhesives which, after physical drying, or after cooling in the case of hotmelt adhesives, form essentially tack-free coatings at room temperature. These adhesives are preferred because the security element transfer material is typically stored rather than being used further immediately after production, which entails rolling up the continuous material. A non-tack-free adhesive layer would lead to blocking of the rolled-up security element transfer material sheets. Security element transfer material pieces of about 100 cm² that have been stacked and stored under a weight of 10 kg at 40° C. for 72 hours are tack-free if they can then be separated from one another without damage.

A heat-sealing adhesive layer is advantageously applied as the last step in the construction of the security element transfer material, since, during the production of a security element transfer material, an elevated temperature and/or an elevated pressure are typically required repeatedly, which could activate any heat- and/or pressure-sensitive adhesive layer already present.

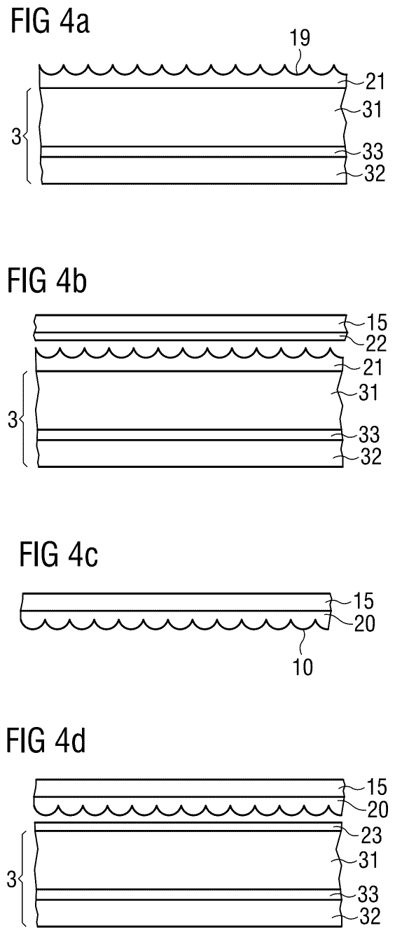

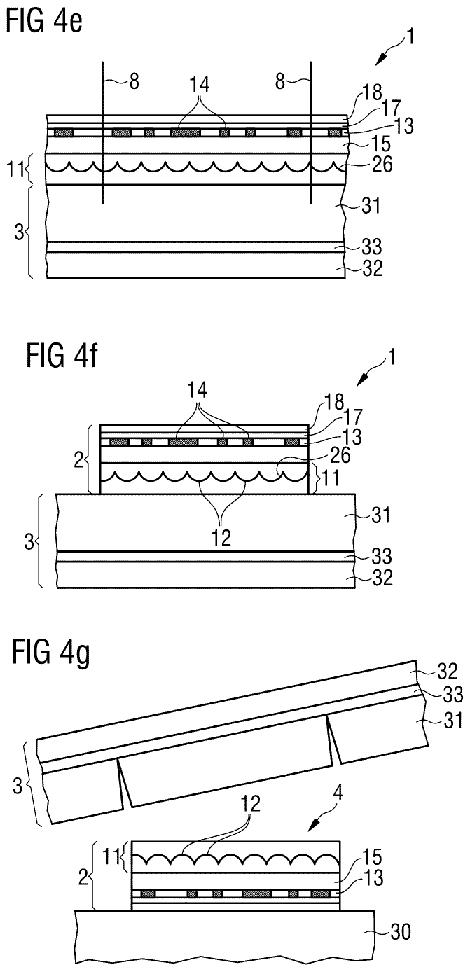

The second variant of the first embodiment of the present invention is described hereinafter with reference to FIGS. 4a to 4g, addressing the differences from the first variant in particular.

First of all, as shown in FIG. 4a, a layer of an embossing varnish 21 having low refractive index is applied to an embossing film 31, and a focusing structure in inverse form 19, for example concave microlenses, is embossed into the embossing varnish layer 21. The embossing film 31, as in the first variant, forms part of the temporary carrier 3 which is pulled away from the security elements when the security elements are transferred to an article of value.

In the embodiment shown in FIG. 4, the temporary carrier 3 is used from the outset in the form of a layer composite composed of a first temporary carrier substrate 31 (embossing film) and a second temporary carrier substrate 32, which are adhesive-bonded inextricably to one another by means of an adhesive layer 33. This is also possible in the first variant, in the same way as the embossing film used in the second variant may at first solely be the first temporary carrier substrate 31, which is adhesive-bonded to the second temporary carrier substrate 32 only after establishment of the layer composite composed of first microoptical arrangement, permanent carrier substrate and first temporary carrier substrate. In both variants of the first embodiment, it is preferable to adhesive-bond the second temporary carrier substrate 32 to the first temporary carrier substrate 31 only at a later stage in the method of producing the security element transfer material.

After the production of the inverse focusing structure 19, as shown in FIG. 4b, a permanent carrier substrate 15, for example a film of PET, is laminated onto the embossing varnish layer 21 by means of a laminating varnish 22 having high refractive index. At the interface to the embossing varnish layer 21, the laminating varnish 22 forms a structure exactly complementary to the inverse focusing structure 19. The interface between the varnish layers forms the focusing elements 12 of the first microoptical arrangement.

Alternatively, as shown in FIG. 4c, a layer of an embossing varnish 20 having high refractive index may be applied to an embossing film 15, and a focusing structure 10, for example convex microlenses, may be embossed into the embossing varnish layer 20. The embossing film 15 is the permanent carrier substrate of the security elements 4 to be transferred, i.e. the film that remains permanently in the security element layer composite as stabilizing element.

Thereafter, as shown in FIG. 4d, the temporary carrier 3 is laminated onto the embossing varnish layer 20 by means of a laminating varnish 23 having low refractive index. The laminating varnish 23 adapts to the embossing structure of the embossing varnish layer 20 and forms an exactly complementary structure at the interface to the embossing structure 10. The interface forms the focusing elements of the first microoptical arrangement.

In both procedures, a first microoptical arrangement 11 having microfocusing elements 12 is obtained, which is formed by an interface 26 having a focusing structure between a varnish layer having high refractive index and a varnish layer having low refractive index, as apparent from FIGS. 4b, 4d and 4e.

By contrast with the first variant of the first embodiment, in the second variant of the first embodiment, a layer of a varnish having high refractive index adjoins the permanent carrier substrate 15.

In order to create the microoptical authenticity feature, a second microoptical arrangement 13 having micromotif elements 14 which, together with the microfocusing elements 12, for example, form a Moiré magnifier arrangement or create a tilted image or some other optical effect is then produced at the surface of the permanent carrier substrate 15 remote from the temporary carrier 3 and the first microoptical arrangement 11. The second microoptical arrangement 13 can be seen in FIG. 4e.

The diagram in FIG. 4e corresponds to the diagram in FIG. 3g of the first variant of the first embodiment. At the method stage shown in FIG. 4e, a layer of a heat-sealing varnish 18 has already been applied to the second microoptical arrangement 13, with provision of a primer layer 17 for the purpose of improving adhesion between the second microoptical arrangement 13 and the transfer adhesive layer 18. The cuts 8 that symbolize the incising of the outline shapes of the later security elements 4 into the security element layer composite 2 are also shown in FIG. 4e. The cuts 8 not only sever the security element layer composite 2, but to some degree also sever the first temporary carrier substrate 31, and can under some circumstances penetrate as far as the adhesive layer 33.

If the mutually corresponding diagrams of FIGS. 3g and 4e are compared with one another, the main difference that can be seen between the first and second variants of the first embodiment is that, in the second variant, the thicknesses of permanent carrier substrate 15 and of the adjoining varnish layer having high refractive index have to be matched to the geometry of the microfocusing elements 12, whereas, in the first variant, the thicknesses of permanent carrier substrate 15 and of the adjoining varnish layer having low refractive index have to be matched to the geometry of the microfocusing elements 12.

The diagrams in FIGS. 4f and 4g correspond to the diagrams in FIGS. 3h and 3i of the first variant. FIG. 4f shows a subregion of the security element transfer material, in cross section, after “stripping”, and FIG. 4g shows the result of the transfer of a security element 4 in the second variant of the first embodiment to a document-of-value substrate 30, for example a banknote substrate.

In the second variant too, the focusing elements 12 formed by the interface 26 between the layers of the varnish having high refractive index and the varnish having low refractive index are within the microoptical arrangement 11 and are well protected against wear, soiling and attempts to take impressions. By contrast with the first variant, however, the layer of the security element 4 facing an observer is a layer of a varnish having low refractive index.

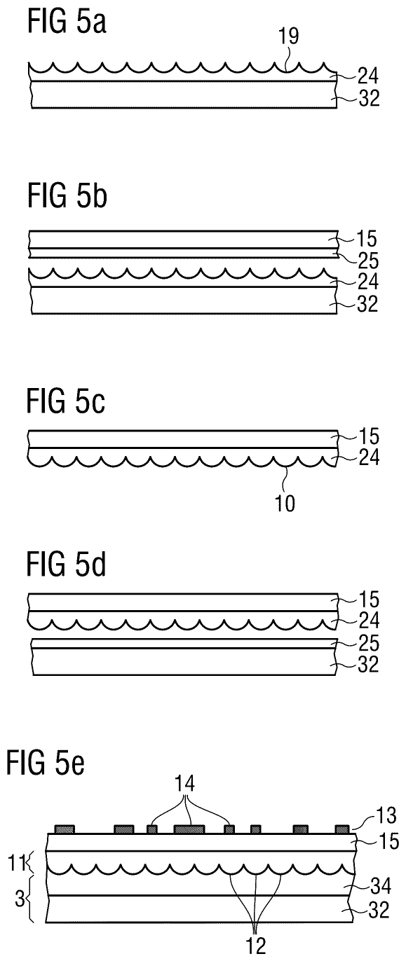

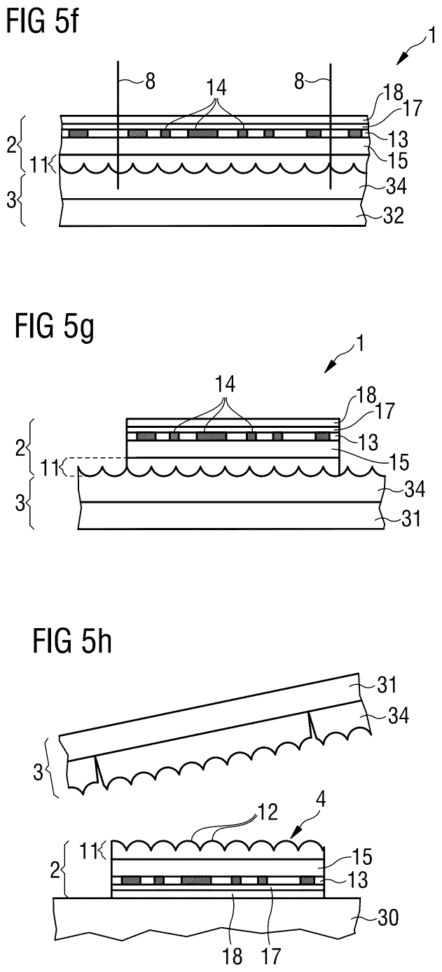

The second embodiment of the present invention as shown in FIGS. 5a to 5h differs from the two variants of the first embodiment in that there is no need to use varnishes having different refractive indices, since only one of the varnish layers remains on the permanent carrier substrate, while the other varnish layer forms part of the temporary carrier and is removed from the security element 4 in the transfer operation to an article of value. The layer of embossing varnish and the layer of laminating varnish must therefore not be bonded inextricably to one another, but must be readily separable from one another when the security element is transferred to an article of value, which gives rise to focusing elements that are exposed on the security element.

A security element transfer material 1 is produced in the second embodiment of the invention by, first of all, as shown in FIG. 5a, applying a layer of an embossing varnish 24 to a surface of an embossing film 32, and embossing a focusing structure in inverse form 19, for example concave microlenses, into the embossing varnish layer 24. There are no specific demands with regard to the embossing varnish 24, and it is possible to use any embossing varnish as customary in the field of security elements. The embossing film 32 forms part of the temporary carrier 3 which is pulled away from the security elements when the security elements are transferred to an article of value, i.e. only temporarily serves as carrier for the security elements. Since the temporary carrier 3 is to be pulled away as a complete layer composite from the security elements to be transferred, the embossing varnish layer 24 must be bonded inextricably to the embossing film 32. In the case of inadequate adhesion between the embossing varnish layer 24 and the embossing film 32, application of the embossing varnish layer 24 is preceded by application of a primer layer to the surface of the embossing film 32 in question or adhesion-promoting pretreatment of the surface of the embossing film 32.

Rather than a single film 32, it is also possible to use a layer composite material composed of two or more temporary carrier substrates that are bonded inextricably to one another by means of an adhesive layer or by means of two or more adhesive layers, for example a temporary carrier as used for both variants of the first embodiment of the invention. However, this is not required in the second embodiment.

Then, as shown in FIG. 5b, a film 15, composed of PET for example, is laminated onto the embossing varnish layer 24 by means of a laminating varnish 25. The laminating varnish must have sufficiently low viscosity that it matches the inverse focusing structure 19 perfectly, i.e. forms an exactly complementary structure at the interface to the inverse focusing structure 19. The complementary focusing structure of the laminating varnish layer 25 in the later security element forms the focusing elements of the first microoptical arrangement, and the film 15 is the permanent carrier substrate of the security element.

In the transfer of the later security element to an article of value, separation between the security element and the temporary carrier takes place at the interface between the varnish layers 24, 25 (FIG. 5h). The laminating varnish layer 25 therefore has to be bonded extricably to the embossing varnish layer 24. In order to ensure that there is problem-free separation of the layers 24, 25 when the security element is transferred, it may be necessary, prior to the laminating application of the permanent carrier substrate 15, to pretreat the embossed surface of the varnish layer 24 in an adhesion-reducing manner or to apply a special release layer to the embossed surface of the varnish layer 24. Such a layer may be a printed layer or else a layer applied by PVD.

There are no specific restrictions with regard to the refractive index of the laminating varnish 25 (the refractive index merely has to be greater than that of the surrounding air). Instead, it is possible to use a conventional laminating varnish as customarily used in the field of security elements. However, it should be noted that the thicknesses of the permanent carrier substrate 15 and the laminating varnish layer 25 have to be matched to the geometry of the microfocusing elements formed by the laminating varnish layer 25 and the refractive index of the laminating varnish layer 25, in order that an appropriate focal length of the microfocusing elements is achieved.

Alternatively, as shown in FIG. 5c, a layer of an embossing varnish 24 may be applied to the permanent carrier substrate 15, and a focusing structure 10, for example convex microlenses, may be embossed into the embossing varnish layer 24. The focusing structure 10 of the embossing varnish layer 24 forms the focusing elements 12 in the later security element. There are no specific restrictions with regard to the refractive index of the embossing varnish layer 24 apart from the aforementioned difference in refractive index compared to air, the ambient medium, and it is possible to use a varnish customary in the field of security elements. However, the thicknesses of the carrier substrate 15 and of the varnish layer 24 have to be matched to the refractive index of the varnish and the geometry of the focusing elements formed by the focusing structure 10, in order to achieve the appropriate focal length for observation of the optical effect.

Subsequently, as shown in FIG. 5d, a film 32 is laminated onto the embossed surface of the embossing varnish layer 24 by means of a laminating varnish 25. The properties of the laminating varnish 25 in this case are essentially immaterial. All that has to be ensured is that the laminating varnish layer 25 is bonded inextricably to the carrier film 32 but extricably to the embossing varnish layer 24, since the laminating varnish layer 25 together with the carrier film 32 forms the temporary carrier 3 of the security element transfer material to be produced, which, when the later security elements are transferred to an article of value, is pulled away from the embossing varnish layer 24 that forms the first microoptical arrangement of the security elements to be transferred. In order to improve the adhesion of the laminating varnish layer to the carrier film 32, it may be necessary to provide a primer layer or to undertake an adhesion-improving pretreatment of the carrier film 32, and it may likewise be necessary to reduce adhesion between the embossing varnish layer and the laminating varnish layer prior to application of the laminating varnish layer by conducting an adhesion-reducing pretreatment of the embossing varnish layer or by applying a special release layer to the surface of the embossing varnish layer.

FIG. 5e shows a method stage in the production of a security element transfer material 1 in the second embodiment of the invention, which corresponds to the method stage shown in FIG. 3f in the production of a security element transfer material 1 in the first embodiment, variant 1, of the present invention. The security element transfer material now has a temporary carrier 3 consisting of a first temporary carrier substrate 34 (the embossing varnish layer 24 or the laminating varnish layer 25) and a second temporary carrier substrate, the carrier film 32, wherein the first temporary carrier substrate 34 and the second temporary carrier substrate 32 are bonded inextricably. Moreover, the security element transfer material has a first microoptical arrangement 11 having the focusing elements 12 which is formed by the laminating varnish layer 25 (FIG. 5b) or by the embossing varnish layer 24 (FIG. 5d). The second microoptical arrangement 13 is created by application, for example printing, of micromotif elements 14 onto the surface of the permanent carrier substrate 15 remote from the first microoptical arrangement 11, such that interaction with the focusing elements 12 results in observation of an optical effect.

For adhesive bonding of the security elements to be transferred to an article of value to be labeled, the final layer applied is a transfer adhesive layer 18, as shown in FIG. 5f. In order to improve adhesion to the second microoptical arrangement 13, a primer layer 17 is provided in the embodiment shown. The first microoptical arrangement 11, the permanent carrier substrate 15, the second microoptical arrangement 13, the primer layer 17 and the transfer adhesive layer 18 form the security element layer composite 2, and the first temporary carrier substrate 34 and the second temporary carrier substrate 32 form the carrier layer composite of the temporary carrier 3.

FIG. 5f shows (analogously to the diagrams in FIG. 3g and in FIG. 4e) a subregion of the security element transfer material 1 after incision of the outline shapes 7 (see FIG. 2) of the later security elements 4 into the security element layer composite 2. The cuts 8 have been made such that the security element layer composite 2 is reliably severed, meaning that they also penetrate into the first temporary carrier substrate 34. But since the second temporary carrier substrate 32 is not cut, the temporary carrier 3, when the security elements are transferred to an article of value, can be pulled away from the security elements as a complete carrier layer composite.

In order to reliably ensure that the second temporary carrier substrate is not cut, it is possible to take analogous measures to those in the case of the temporary carrier 3 in the first embodiment. For example, a laser protection layer may be provided between the first temporary carrier substrate 34 and the second temporary carrier substrate 32 and/or the varnish layer that forms the first temporary carrier substrate 34 may be equipped with laser-absorbing or laser-reflecting substances, and the cutting may then be conducted with a laser. In addition, rather than the second temporary carrier substrate 32, it is also possible to use a temporary carrier 3 as described in connection with the first embodiment of the present invention. Such a temporary layer composite has a multitude of layers and hence offers a high degree of certainty that the temporary carrier will not be torn in the transfer operation, even though the security element outline shapes are being incised by less precise methods than by means of a laser, for example by punching.

FIG. 5g shows the state after “stripping”, analogously to the diagrams in FIG. 3h and FIG. 4f. It is apparent that the separation between the security element layer composite 2 and the temporary carrier 3 occurs between the embossing varnish layer and the laminating varnish layer, which is the reason why these varnish layers have to be bonded extricably to one another, whereas the individual layers of the security element layer composite 2 on the one hand and the individual layers of the temporary carrier on the other hand have to be bonded inextricably to one another.

The result of the transfer of a security element 4 to an article of value is illustrated in FIG. 5h, analogously to the diagrams in FIG. 3i and FIG. 4g. It is apparent that the pulling of the temporary carrier 3 away from the security element 4 damaged the varnish layer 34 but not the second temporary carrier substrate 32, and so it was possible to pull away the temporary carrier 3 as a complete layer composite.

The security element 4 transferred to the document-of-value substrate 30 has a first microoptical arrangement 11 having focusing elements 12 that are formed either by the laminating varnish 25 (FIG. 5b) or by the embossing varnish 24 (FIG. 5c).

The second embodiment has the advantage that no specific varnishes have to be used, and it is therefore possible to work very inexpensively.

In a third embodiment of the present invention, the security elements of the security element transfer material contain solely the first microoptical arrangement of the microoptical authenticity feature, while the second microoptical arrangement is formed on the article of value to be labeled itself.

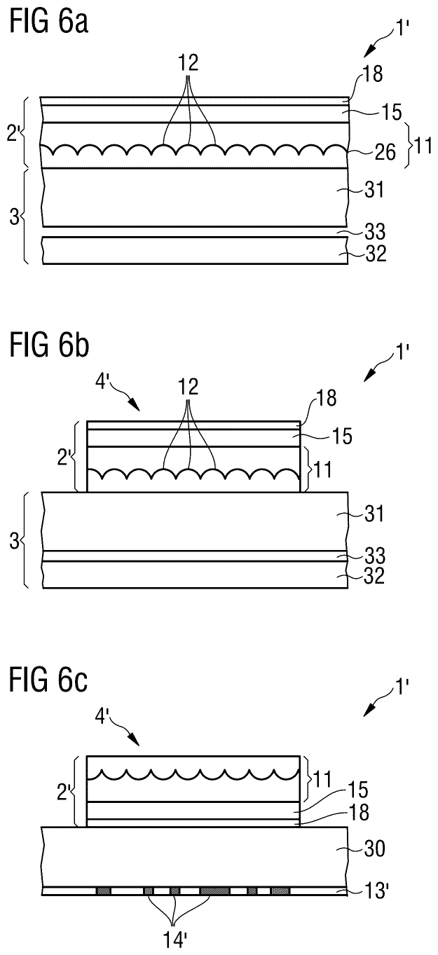

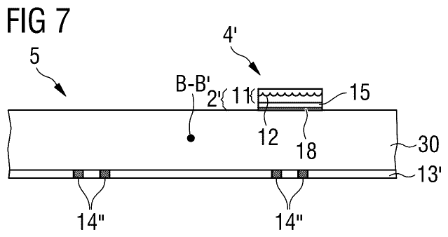

The third embodiment is illustrated in FIGS. 6a, 6b, 6c and 7. FIGS. 6a to 6c and FIG. 7 show a security element layer composite 2′ or a security element 4′ in which the first microoptical arrangement 11 is formed as in the two variants of the first embodiment, i.e. from a layer of a high-refracting varnish and a layer of a low-refracting varnish, where the focusing elements 12 are formed by the interface between the high-refracting varnish and the low-refracting varnish. Rather than the first microoptical arrangement 11 shown, in the first embodiment, however, it is likewise possible to use a first microoptical arrangement 11 according to the second embodiment, as described in FIGS. 5a to 5h.

FIG. 6a shows a detail from a security element transfer material 1′, where the structure of the security element transfer material 1′ differs from the structure shown in FIG. 3e merely in that a transfer adhesive layer 18 is applied to the permanent carrier substrate 15. By contrast with the security element layer composite 2 illustrated in FIG. 3g, the security element layer composite 2′ shown in FIG. 6a does not contain a second microoptical arrangement, i.e. any micromotif elements. The primer layer 17 shown in FIG. 3g has also been omitted, but may optionally also be provided.

FIG. 6b shows the security element transfer material 1′ after the “stripping” of excess security element layer composite material, analogously to the diagrams in FIGS. 3h, 4f and 5g. The security elements 4′ that are now in the form of individual elements on the temporary carrier 3 have only a first microoptical arrangement 11, but no second microoptical arrangement. The security elements 4′ are therefore not capable of creating any optical effect by interaction of a first microoptical arrangement and a second microoptical arrangement.

In the third embodiment of the present invention, the second microoptical arrangement is provided on the article of value to be labeled. The security element and the second microoptical arrangement must be arranged relative to one another on the article of value such that the first microoptical arrangement of the security element and the second microoptical arrangement present on the article of value can interact to create an optical effect. Possible arrangements are illustrated in FIGS. 1, 6c and 7.

In the embodiment shown in FIG. 6c, the security element 4′ and the second microoptical arrangement 13′ having the micromotif elements 14′ are disposed on opposite surfaces of a transparent document-of-value substrate, for example of a film banknote. An identical arrangement is also possible when the document-of-value substrate 30 is a substrate that is nontransparent but has an aperture which is closed by the security element 4′.

Shown on the right-hand side of the document of value 5 shown in front view in FIG. 1 is such a security element 4, which closes an aperture 9 in the document of value. The security element 4 is a security element according to the first or second embodiment of the present invention, meaning that it contains a second microoptical arrangement as shown or indicated in FIG. 1 as micromotif elements 14. The result is the same appearance to an observer of the microoptical authenticity feature when a security element 4′ and a second microoptical arrangement 13′ are arranged on a transparent document-of-value substrate, as shown in FIG. 6c and on the right-hand side of FIG. 7. However, the distinctly greater distance between the first microoptical arrangement 11 and the second microoptical arrangement 13′ generally results in a different geometry of the focusing elements 12.

An alternative arrangement of a security element 4′ and a second microoptical arrangement 13′ in the third embodiment of the present invention is likewise shown or indicated in FIGS. 7 and 1. FIG. 1 shows a document of value such as a banknote in front view, where the line B-B′ indicates the place where the banknote is supposed to be folded.

FIG. 7 shows a cross section through part of the banknote of FIG. 1 along the line C-C′. The fold line B-B′ is apparent as a dot in FIG. 7. If a security element 4′ without a second microoptical arrangement and a second microoptical arrangement as shown in FIG. 7 or indicated as micromotif elements 14″ are provided on a transparent document-of-value substrate 30 or on a document-of-value substrate 30 having an aperture in the region of the security element 4′, as shown in FIG. 7, the first microoptical arrangement of the security element 4′ may be brought into line with the second microoptical arrangement 13′ by folding the document of value along the line B-B′, so as to create an optical effect. In this respect, the third embodiment of the present invention offers the possibility of self-verification of a document of value.

The inventive methods of producing security element transfer materials make it possible to produce film security elements having microoptical authenticity features in excellent quality with minimal use of costly varnish materials and to transfer them without difficulty to an article of value without risk of damage to the sensitive microoptical structures.

1.-16. (canceled)

17. A method of producing a security element transfer material having a security element layer composite and a temporary carrier which is bonded extricably to the security element layer composite, wherein the security element layer composite has a layer having a first microoptical arrangement having a multitude of focusing elements, a layer having a second microoptical arrangement having a multitude of micromotif elements, and a permanent carrier substrate between the layers having the first and second microoptical arrangements, wherein the first and second microoptical arrangements interact to create an optical effect, and wherein the method has the following steps:
(1) producing the first microoptical arrangement by
(a) applying an embossing varnish having a refractive index n>1.55, to a surface of the temporary carrier, wherein the embossing varnish layer is bonded extricably to the temporary carrier,
embossing a focusing structure into the embossing varnish layer, and
laminating the permanent carrier substrate onto the focusing structure by means of a laminating varnish having a refractive index n<1.45, wherein the laminating varnish layer, at the interface to the embossing varnish layer, in creating the focusing elements, forms a structure complementary to the focusing structure and bonds the permanent carrier substrate to the embossing varnish layer,
or by
(b) applying an embossing varnish having a refractive index n<1.45, to a surface of the permanent carrier substrate, wherein the embossing varnish layer is bonded inextricably to the permanent carrier substrate,
inversely embossing a focusing structure into the embossing varnish layer, and
laminating the temporary carrier onto the inverse focusing structure by means of a laminating varnish having a refractive index n>1.55, wherein the laminating varnish layer, at the interface to the embossing varnish layer, in creating the focusing elements, forms a structure complementary to the inverse focusing structure and is bonded inextricably to the embossing varnish layer, but extricably to the temporary carrier,
(2) producing the second microoptical arrangement by forming the micromotif elements on the surface of the permanent carrier substrate remote from the temporary carrier,
(3) optionally coating part or all of the area of the second microoptical arrangement with at least one further layer,
(4) applying a transfer adhesive layer to the second microoptical arrangement and/or the at least one further layer, and
(5) incising the outline shapes of the security elements to be transferred, wherein
the temporary carrier used in step (1) is a carrier layer composite consisting of a first temporary carrier substrate and a second temporary carrier substrate that are inextricably adhesive-bonded by means of an adhesive layer, or
the temporary carrier used in step (1) is a first carrier substrate, and, prior to step (5), the first carrier substrate is inextricably adhesive-bonded to a second carrier substrate for production of a carrier layer composite, and wherein
in step (5), at least the second temporary carrier substrate is not cut, such that the temporary carrier can be separated off as a complete carrier layer composite.

18. A method of producing a security element transfer material having a security element layer composite and a temporary carrier which is bonded extricably to the security element layer composite, wherein the security element layer composite has a layer having a first microoptical arrangement having a multitude of focusing elements, a layer having a second microoptical arrangement having a multitude of micromotif elements, and a permanent carrier substrate between the layers having the first and second microoptical arrangements, wherein the first and second microoptical arrangements interact to create an optical effect, and wherein the method has the following steps:
(1) producing the first microoptical arrangement by
(a) applying an embossing varnish having a refractive index n<1.45, to a surface of the temporary carrier, wherein the embossing varnish layer is bonded extricably to the temporary carrier,
inversely embossing a focusing structure into the embossing varnish layer, and
laminating the permanent carrier substrate onto the inverse focusing structure by means of a laminating varnish having a refractive index n>1.55, wherein the laminating varnish layer, at the interface to the embossing varnish layer, in creating the focusing elements, forms a structure complementary to the inverse focusing structure and bonds the permanent carrier substrate inextricably to the embossing varnish layer,
or by
(b) applying an embossing varnish having a refractive index n>1.55, to a surface of the permanent carrier substrate, wherein the embossing varnish layer is bonded inextricably to the permanent carrier substrate,
embossing a focusing structure into the embossing varnish layer, and
laminating the temporary carrier onto the focusing structure by means of a laminating varnish having a refractive index n<1.45, wherein the laminating varnish layer, at the interface to the embossing varnish layer, in creating the focusing elements, forms a structure complementary to the focusing structure and is bonded inextricably to the embossing varnish layer, but extricably to the temporary carrier,
(2) producing the second microoptical arrangement by forming the micromotif elements on the surface of the permanent carrier substrate remote from the temporary carrier,
(3) optionally coating part or all of the area of the second microoptical arrangement with at least one further layer,
(4) applying a transfer adhesive layer to the second microoptical arrangement and/or the at least one further layer, and
(5) incising the outline shapes of the security elements to be transferred, wherein
the temporary carrier used in step (1) is a carrier layer composite consisting of a first temporary carrier substrate and a second temporary carrier substrate that are inextricably adhesive-bonded by means of an adhesive layer, or
the temporary carrier used in step (1) is a first carrier substrate, and, prior to step (5), the first carrier substrate is inextricably adhesive-bonded to a second carrier substrate for production of a carrier layer composite, and wherein
in step (5), at least the second temporary carrier substrate is not cut, such that the temporary carrier can be separated off as a complete carrier layer composite.

19. The method of producing a security element transfer material according to claim 17, wherein the adhesive layer of the temporary carrier is produced using a self-healing adhesive, and the outline shapes of the security elements to be transferred are incised while the adhesive has not yet cured.

20. The method of producing a security element transfer material according to claim 17, wherein the first carrier substrate is inextricably adhesive-bonded to the second carrier substrate to create a carrier layer composite before step.

21. A method of producing a security element transfer material having a security element layer composite and a temporary carrier in the form of a carrier layer composite which is bonded extricably to the security element layer composite, wherein the security element layer composite has a layer having a first microoptical arrangement having a multitude of focusing elements, a layer having a second microoptical arrangement having a multitude of micromotif elements, and a permanent carrier substrate between the layers having the first and second microoptical arrangements, wherein the first and second microoptical arrangements interact to create an optical effect, and wherein the method has the following steps:
(1) producing the first microoptical arrangement by
(a) applying an embossing varnish to a surface of a temporary carrier substrate, wherein the embossing varnish layer, in forming the temporary carrier composite, is bonded inextricably to the temporary carrier substrate,
inversely embossing a focusing structure into the embossing varnish layer, and
laminating the permanent carrier substrate onto the inverse focusing structure by means of a laminating varnish, wherein the laminating varnish layer, at the interface to the embossing varnish layer, in creating the focusing elements, forms a structure complementary to the inverse focusing structure and is bonded inextricably to the permanent carrier substrate and extricably to the embossing varnish layer,
or by
(b) applying an embossing varnish to a surface of a permanent carrier substrate,
embossing a focusing structure into the embossing varnish layer for creation of the focusing elements, and
laminating a temporary carrier substrate onto the focusing structure by means of a laminating varnish, wherein the laminating varnish layer, at the interface to the embossing varnish layer, forms a structure complementary to the focusing structure and, in forming the temporary carrier composite, is bonded inextricably to the temporary carrier substrate and extricably to the embossing varnish layer,
(2) producing the second microoptical arrangement by forming the micromotif elements on the surface of the permanent carrier substrate remote from the temporary carrier layer composite,
(3) optionally coating part or all of the area of the second microoptical arrangement with at least one further layer,
(4) applying a transfer adhesive layer to the second microoptical arrangement and/or the at least one further layer, and
(5) incising outline shapes of the security elements to be transferred without cutting the temporary carrier substrate, such that the temporary carrier can be separated off as a complete carrier layer composite.

22. The method of producing a security element transfer material according to claim 17, wherein the layer composite material of the security element layer composite is removed from the security element transfer material outside the outline shapes of the security elements.

23. A security element transfer material having a security element layer composite and a temporary carrier bonded extricably to the security element layer composite, wherein
the security element layer composite has a layer having a first microoptical arrangement having a multitude of focusing elements, a layer having a second microoptical arrangement having a multitude of micromotif elements, and a permanent carrier substrate between the layer having the first microoptical arrangement and the layer having the second microoptical arrangement, and a transfer adhesive layer as an outer layer of the security element layer composite, where the first the second microoptical arrangement interact to create an optical effect, and
the temporary carrier has a carrier layer composite consisting of a first temporary carrier substrate and a second temporary carrier substrate that are inextricably bonded by means of an adhesive layer, and wherein
the first microoptical arrangement consists of
(a) a layer of an embossing varnish having a refractive index n>1.55, which is bonded extricably to the temporary carrier and into which a focusing structure is embossed, and
a layer of a laminating varnish having a refractive index n<1.45, which is bonded inextricably to the embossing varnish layer and to the permanent carrier substrate and which has a structure complementary to the focusing structure at the interface to the embossing varnish layer, such that the interface forms focusing elements,
or of
(b) a layer of an embossing varnish having a refractive index n<1.45, which is bonded inextricably to the permanent carrier substrate and into which an inverse focusing structure is embossed, and
a layer of a laminating varnish having a refractive index n>1.55, which is bonded inextricably to the embossing varnish layer and extricably to the temporary carrier and which has a structure complementary to the inverse focusing structure at the interface to the embossing varnish layer, such that the interface forms focusing elements,
wherein outline shapes of the security elements to be transferred are precut in the security element layer composite and cuts do not penetrate at least into the second temporary carrier substrate, such that the temporary carrier can be separated off as a complete carrier layer composite.

24. A security element transfer material having a security element layer composite and a temporary carrier bonded extricably to the security element layer composite, wherein
the security element layer composite has a layer having a first microoptical arrangement having a multitude of focusing elements, a layer having a second microoptical arrangement having a multitude of micromotif elements, and a permanent carrier substrate between the layer having the first microoptical arrangement and the layer having the second microoptical arrangement, and a transfer adhesive layer as an outer layer of the security element layer composite, where the first and second microoptical arrangements interact to create an optical effect, and
the temporary carrier has a carrier layer composite consisting of a first temporary carrier substrate and a second temporary carrier substrate that are inextricably bonded by means of an adhesive layer, and wherein
the first microoptical arrangement consists of
(a) a layer of an embossing varnish having a refractive index n<1.45, which is bonded extricably to the temporary carrier and into which an inverse focusing structure is embossed, and
a layer of a laminating varnish having a refractive index n>1.55, which is bonded inextricably to the embossing varnish layer and to the permanent carrier substrate and which has a structure complementary to the inverse focusing structure at the interface to the embossing varnish layer, such that the interface forms focusing elements,
or of
(b) a layer of an embossing varnish having a refractive index n>1.55, which is bonded inextricably to the permanent carrier substrate and into which a focusing structure is embossed, and
a layer of a laminating varnish having a refractive index n<1.45, which is bonded inextricably to the embossing varnish layer and extricably to the temporary carrier and which has a structure complementary to the focusing structure at the interface to the embossing varnish layer, such that the interface forms focusing elements,
wherein outline shapes of the security elements to be transferred are precut in the security element layer composite and cuts do not penetrate at least into the second temporary carrier substrate, such that the temporary carrier can be separated off as a complete carrier layer composite.

25. The security element transfer material according to claim 23, wherein the adhesive layer of the temporary carrier consists of a self-healing adhesive.

26. A security element transfer material having a security element layer composite and a temporary carrier bonded extricably to the security element layer composite, wherein
the security element layer composite has a layer having a first microoptical arrangement having a multitude of focusing elements, a layer having a second microoptical arrangement having a multitude of micromotif elements, a permanent carrier substrate between the layer having the first microoptical arrangement and the layer having the second microoptical arrangement, and a transfer adhesive layer as an outer layer of the security element layer composite, where the first microoptical arrangement and the second microoptical arrangement interact to create an optical effect, and
the temporary carrier has a temporary carrier substrate and a temporary varnish layer on one surface of the temporary carrier substrate, wherein the temporary carrier substrate and the temporary varnish layer are bonded inextricably to one another to form a carrier layer composite, and the temporary varnish layer is either (a) a layer of an embossing varnish into which an inverse focusing structure has been embossed, or (b) a layer of a laminating varnish, and
the first microoptical arrangement
(a) when the temporary varnish layer is a layer of an embossing varnish into which an inverse focusing structure is embossed, consists of a layer of a laminating varnish which is bonded inextricably to the permanent carrier material and extricably to the temporary embossing varnish layer and which has, at the interface to the temporary embossing varnish layer, a structure which is complementary to the inverse focusing structure and forms the focusing elements,
or
(b) when the temporary varnish layer is a layer of a laminating varnish, consists of a layer of an embossing varnish which is bonded inextricably to the permanent carrier substrate and extricably to the temporary laminating varnish layer and into which a focusing structure is embossed, which forms the focusing elements,
wherein outline shapes of the security elements to be transferred are precut in the security element layer composite and cuts do not penetrate at least into the temporary carrier substrate, such that the temporary carrier can be separated off as a complete carrier layer composite.

27. The security element transfer material according to claim 23, wherein the layer composite material has been removed from the security element layer composite outside the outline shapes of the security elements, such that the security element transfer material has gaps in the security element layer composite, while the temporary carrier has no gaps.

28. A method of indicating the authenticity of an article of value by means of a microoptical authenticity feature, comprising transferring a security element from a security element transfer material to a surface of the article of value by
combining the security element transfer material according to claim 23, and the article of value,
compressing the security element transfer material in the region of the security element to be transferred and the article of value, optionally at elevated temperature, and
separating the temporary carrier as complete carrier layer composite from the transferred security element.

29. A method of indicating the authenticity of an article of value by means of a microoptical authenticity feature, comprising
(1) producing a security element transfer material having a security element layer composite and a temporary carrier bonded extricably to the security element layer composite, wherein the security element layer composite has a layer having a first microoptical arrangement having a multitude of focusing elements, a transfer adhesive layer and a permanent carrier substrate between the layer having the first microoptical arrangement and the transfer adhesive layer,
and wherein the security element transfer material is produced by
creating the first microoptical arrangement according to claim 17,
optionally coating part or all of the area of the first microoptical arrangement with at least one further layer,
applying the transfer adhesive layer to the first microoptical arrangement and/or the at least one further layer, and
incising outline shapes of the security elements to be transferred, wherein (a) the temporary carrier used is a carrier layer composite consisting of a first temporary carrier substrate and a second temporary carrier substrate which are inextricably adhesive-bonded by means of an adhesive layer, or (b) the temporary carrier used is a first carrier substrate, and application of the transfer adhesive layer is preceded by inextricable adhesive-bonding of the first carrier substrate to a second carrier substrate for creation of a carrier layer composite,
and wherein at least the second temporary carrier substrate is not cut, such that the temporary carrier can be separated off as a complete carrier layer composite,
optionally removing the layer composite material of the security element layer composite outside the outline shapes of the security elements from the security element transfer material,
(2) transferring a security element from the security element transfer material to a surface of the article of value by
combining the security element transfer material and the substrate of the article of value,
compressing the security element transfer material in the region of the security element to be transferred and the substrate of the article of value, optionally at elevated temperature, and
separating the temporary carrier as complete carrier layer composite from the transferred security element, and
(3) applying a second microoptical arrangement having a multitude of micromotif elements to a surface of the substrate of the article of value in such a way that the first microoptical arrangement and the second microoptical arrangement interact or can interact with creation of an optical effect, in order to form the microoptical authenticity feature.

30. A method of indicating the authenticity of an article of value by means of a microoptical authenticity feature, comprising
(1) producing a security element transfer material having a security element layer composite and a temporary carrier in the form of a carrier layer composite which is bonded extricably to the security element layer composite, wherein the security element layer composite has a layer having a first microoptical arrangement having a multitude of focusing elements, a transfer adhesive layer and a permanent carrier substrate between the layer having the first microoptical arrangement and the transfer adhesive layer, and wherein the security element transfer material is produced by
creating the first microoptical arrangement as specified in claim 21,
optionally coating part or all of the area of the first microoptical arrangement with at least one further layer,
applying the transfer adhesive layer to the first microoptical arrangement and/or the at least one further layer, and
incising outline shapes of the security elements to be transferred without cutting the temporary carrier substrate, such that the temporary carrier can be separated off as a complete carrier layer composite,
optionally removing the layer composite material of the security element layer composite outside the outline shapes of the security elements from the security element transfer material,
(2) transferring a security element from the security element transfer material to a surface of the article of value by
combining the security element transfer material and the substrate of the article of value,
compressing the security element transfer material in the region of the security element to be transferred and the substrate of the article of value, optionally at elevated temperature, and
separating the temporary carrier as complete carrier layer composite from the transferred security element,
(3) applying a second microoptical arrangement having a multitude of micromotif elements to a surface of the substrate of the article of value in such a way that the first microoptical arrangement and the second microoptical arrangement interact or can interact with creation of an optical effect, in order to form the microoptical authenticity feature.

31. An article of value which has been equipped with a security element using security element transfer material, or which has been equipped with a security element and a second microoptical arrangement by a method of indicating authenticity according to claim 28.

32. The article of value according to claim 31, wherein the article of value has an aperture, and the security element is mounted such that it essentially closes the aperture.
